(19) United States
(12) Patent Application Publication
(10) Pub. No.: US 2008/0132382 A1
(43) Pub. Date: Jun. 5, 2008

(54) Actuating Device

(76) Inventor: Jurgen Sturzer, Aiterhofen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/816,156

(22) PCT Filed: Jan. 24, 2006
(86) PCT No.: PCT/EP06/50382

§ 371 Date: Aug. 13, 2007

(30) Foreign Application Priority Data
Feb. 25, 2005 (DE) 10 2005 008 793.0

(51) Int. Cl. B60T 13/74; B60T 1/06; B60W 10/18; F16D 27/00; H02K 7/102

(52) U.S. Cl. 477/197; 192/219.4; 192/84.91; 192/84.961; 188/18 A; 188/17

(57) ABSTRACT

An actuating device has an electric motor actuator, at least one output shaft coupled to at least one positioning element and a braking to stop device coupled with the electric motor actuator on the input side and with the output shaft on the output side or includes the output shaft. The braking to stop device has a brake body coupled with the output shaft and is arranged such that it is axially displaceable. The braking to stop device is constructed such that it makes it possible to convert a rotational motion on the input side into the axial lifting motion of the braking body for the displacement thereof from a braking position or positioning the braking body in a braking position. The braking to stop device is also constructed in such a way that it transmits the rotational motion on the input side to the braking body.

### CROSS-REFERENCE TO RELATED APPLICATIONS

This application is a U.S. national stage application of International Application No. PCT/EP2006/050382 filed Jan. 24, 2006, which designates the United States of America, and claims priority to German application number 10 2005 008 793.0 filed Feb. 25, 2005, the contents of which are hereby incorporated by reference in their entirety.

### TECHNICAL FIELD

The invention relates to an actuating device, especially an actuating device for an electrically actuatable brake comprising an electric motor actuator and at least one output shaft.

### BACKGROUND

An electrically actuatable brake, e.g. a parking brake in a motor vehicle, uses an electric motor actuator in order to create braking force which is fed to the respective brakes on the wheels of the vehicle. The braking force at the brakes should also be maintained once the electric motor actuator has been switched off, in order for example to prevent the motor vehicle from rolling away.

### SUMMARY

According to an embodiment an actuating device may comprise an electric motor actuator, at least one output shaft, at least one positioning element, which is coupled with the at least one output shaft and which is embodied for coupling with a transmission element and that interoperates with the transmission element to convert a rotational motion of the at least one output shaft into a linear motion of the transmission element, a braking to stop device, which is coupled on the input side with the electric motor actuator and which is coupled with the at least one output shaft or forms a constructional unit with the at least one output shaft and which features a braking body which is coupled with the at least one output shaft and which is arranged to enable it to be axially displaced and which is embodied to convert an input-side rotational motion within a predetermined angular range into an axial lifting of the braking body out of a braking position of the braking body or into the braking position of the braking body and for transmitting the input-side rotational motion to the braking body.

### BRIEF DESCRIPTION OF THE DRAWINGS

Exemplary embodiments of the invention are explained below with reference to schematic diagrams.

The figures show:

FIG. 1a a first arrangement of an actuating device in a motor vehicle,

FIG. 1b a second arrangement of the actuating device in the motor vehicle,

FIG. 2 an actuating device,

FIG. 3 a first shaft,

FIG. 4 a drive body,

FIG. 5 a cross-section through the drive body, through a braking body and through a positioning body,

FIGS. 6a,b a first arrangement of positioning elements,

FIGS. 7a,b a second arrangement of the positioning elements,

FIG. 8 a second shaft,

FIG. 9 two output shafts with threaded spindles.

### DETAILED DESCRIPTION

The outstanding feature according to various embodiments is an actuating device which includes an electric motor actuator, at least one output shaft, at least one positioning element and a braking to stop device. The at least one positioning element is coupled with the at least one output shaft and is embodied for coupling with a transmission element. The positioning element interoperates with the transmission element to convert a rotational motion of the at least one output shaft into a linear motion of the transmission element.

The braking to stop device is coupled on the input side with the electric motor actuator and is coupled with the at least one output shaft or includes the at least one output shaft Furthermore the braking to stop device comprises a brake body, which is coupled with the at least one output shaft and is arranged in such a way that it is axially displaceable. The braking to stop device is embodied to convert an input-side rotational motion within a predetermined angular range into an axial lifting motion of the braking body out of the braking position of the braking body or into the braking position of the braking body. The braking to stop device is further embodied for transmitting the input-side rotational motion to the braking body.

The advantage is that the braking body can be moved out of its braking position through the input-side rotational motion which is created by the electric motor actuator, and then the input-side rotational motion can be transmitted with high efficiency to the at least one output shaft. This means that the electric motor actuator has a low power requirement, so that the electric motor actuator can be a very low-cost unit. Furthermore any control device which may be required to control the electric motor actuator can be embodied in a simple and low-cost manner, by using relays instead of semiconductor bridges for example.

In an advantageous embodiment of the actuating device the braking to stop device is embodied for the respective transmission of the input-side rotational motion to the braking body for two opposing drive directions of the electric motor actuator. The advantage of this is that the at least one output shaft can be driven in both drive directions with high efficiency.

In a further advantageous embodiment of the actuating device the braking to stop device includes a spring element which is embodied so that the spring element transmits a force to the braking body such that the braking body assumes the braking position when the electric motor actuator is inactive. The electric motor actuator is inactive for example if the torque created by this actuator is not sufficient to move the braking body out of its braking position. This is especially the case if no power is being supplied to the electric motor actuator. The provision of the spring element means that the braking body reliably assumes its braking position, so that the at least one output shaft can be held in its rotational position.

In a further advantageous embodiment of the actuating device the braking body is embodied as a friction ring. The advantage of this is that such a braking body can be very simple and low-cost.

In a further advantageous embodiment of the actuating device the braking body is embodied in the form of a disk and is part of a disk brake. The advantage is that the disk brake has a very good braking effect and thereby enables the rotational position of the output shaft to be held very securely and reliably.

In a further advantageous embodiment of the actuating device the braking to stop device includes a drive body which is coupled with the electric motor actuator. Furthermore the drive body is coupled via at least one positioning body with the braking body. The advantage of this is that such a braking to stop device is simple.

In this connection it is especially advantageous, on the side of the drive body facing the braking body and/or on the side of the braking body facing the drive body, for at least one ramp-type contour to be embodied for converting a rotational motion of the drive body into the axial lifting of the braking body in conjunction with the at least one positioning body. The advantage of this is that the rotational motion of the drive body can be converted very simply into the axial lifting of the braking body and the conversion can take place so that the power requirement of the electric motor actuator is low.

In a further advantageous embodiment of the actuating device the at least one positioning body is embodied in a spherical form. Alternately the at least one positioning body is embodied in a cylindrical form. The advantage is that such positioning bodies are very simple and cheap to manufacture. Furthermore such positioning bodies can be moved especially easily by rolling them with low friction losses and high efficiency up or down the ramp-type contour.

In a further advantageous embodiment of the actuating device the at least one output shaft comprises a spindle. The advantage of this is that the rotational motion of the at least one output shaft can be converted very simply into the linear motion of the transmission element. This is also possible by embodying the at least one positioning element as a cable sheave. A transmission element, typically a cable, is able to be pulled by winding it up for example through such a cable sheave.

Elements which are constructed or function in the same way are labeled with the same reference symbols in all the figures.

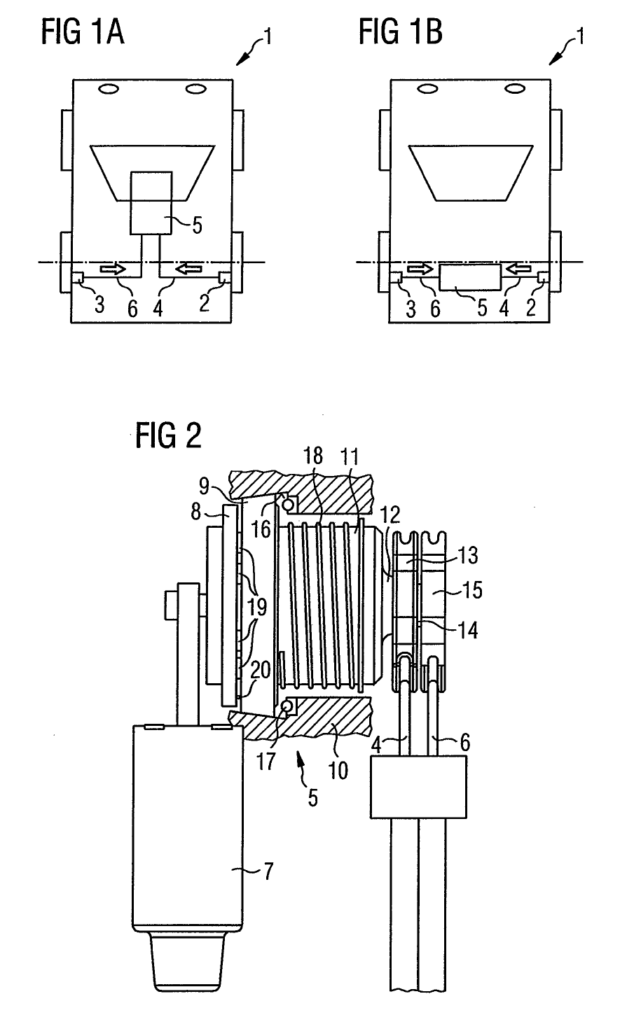

FIG. 1a shows a motor vehicle 1, which, on a rear axle of the vehicle, has a first brake 2 for a wheel on the right hand side and a second brake 3 for a wheel on the left hand side. The first brake 2 is coupled via a first brake cable 4 with an actuating device 5, which for example is a part of an electrically actuatable brake, especially an electronic parking brake, of the vehicle 1. The second brake 3 is correspondingly coupled via a second brake cable 6 with the actuating device 5. The actuating device 5 is for example arranged in a central channel of the vehicle 1, e.g. in a region of a parking brake.

Alternately the actuating device 5 can however also be arranged in a region of a vehicle axle, for example the rear axle of the vehicle 1 (FIG. 1b). For this purpose the actuating device 5 can be preferably mounted on the rear axle of the vehicle 1. The advantage of this is that such an arrangement of vehicle axle and actuating device 5 can be pre-assembled for assembly of the vehicle 1. This can simplify the assembly of the vehicle 1. The actuating device 5 can however also be mounted on a chassis of the vehicle 1. The first brake cable 4 and the second brake cable 6 extend in parallel to the rear axle of the vehicle 1 in opposite directions and thus at right angles to the longitudinal axis of the vehicle 1.

The first brake cable 4 and the second brake cable 6 are to able to be moved a predetermined distance and/or tightened by a predetermined force by the actuating device 5, to enable the first brake 2 and the second brake 3 to be operated reliably.

The actuating device 5 includes an electric motor actuator 7 and a braking to stop device (FIG. 2). The braking to stop device includes a drive body 8, a braking body 9, a housing 10 and a first shaft 11. The actuating device further includes a first output shaft 12, which is coupled with a first cable sheave 13, and a second output shaft which is coupled with a second cable sheave 15. The first cable sheave 13 and the second cable sheave 15 can also be referred to as positioning elements. The first cable sheave 13 and the second cable sheave 15 are embodied so that they are able to be coupled with the first brake cable 4 or with the second brake cable 6 respectively. The first brake cable 4 and the second brake cable 6 each form a transmission element for transmitting a braking force to the first brake 2 or the second brake 3. The first cable sheave 13 and the second cable sheave 15 are embodied so that a rotational motion of the first output shaft 12 or of the second output shaft 14 is converted into a linear motion of the first brake cable 4 or of the second brake cable 6.

The braking body 9, the first shaft 11, the first output shaft 12 and the second output shaft 14 are coupled with each other in such a way that a rotational motion of the braking body 9 can be transmitted via the shaft 11, the first output shaft 12 and the second output shaft 14 to the first cable sheave 13 and the second cable sheave 15. Likewise a torque, which is transmitted for example via the first brake cable 4 or the second brake cable 6 to the first output shaft 12 or the second output shaft 14, will be transmitted via the first shaft 11 to the braking body 9.

The first shaft 11 may be coupled with the first output shaft 12 or the second output shaft 14 preferably via a compensating device, for example a differential gear, through which different lengths of the first brake cable 4 and of the second brake cable tolerances of the first brake cable 2 or the second brake cable 3 or different torques at the first output shaft 12 and the second output shaft 14 can be compensated for. Such a compensating device can for example be especially small and compact and arranged in the first shaft 11 or in the braking body 9, it can however also be arranged in another location between the braking body 9 and the first output shaft 12 and the second output shaft 14 or also include the first output shaft 12 or the second output shaft 14. The first shaft 11, the first output shaft 12 and the second output shaft 14 can however also be rigidly coupled with each other or be embodied as a common output shaft. Likewise only a single cable sheave and a single brake cable or more than two cable sheaves and brake cables can be provided.

The housing 10 includes a braking surface 16. An axial bearing 17 can further be provided on the housing 10. In a braking position of the braking body 9 the braking body 9 sits on the braking surface 16 of the housing 10. The braking to stop device further includes a spring element 18, which exerts a force on the braking body 9 such that this body is pressed into the braking position and held there. Suitable dimensioning of the spring element 18, of the braking body 9 and of the braking surface 16 can thus prevent the torque operating on the first shaft 11 leading to a twisting of the braking body of the first shaft 11 and thereby also of the first output shaft 12, of the second output shaft of the first cable sheave 13 and of the second cable sheave 15. A rotational position of the first cable sheave 13 and of the second cable sheave 15 can in this way be reliably held and the braking force can be maintained at the first brake 2 and the second brake 3.

The drive body 8 is arranged in parallel to the braking body 9 and coupled with it via four positioning bodies 19. Furthermore the drive body 8 and the braking body 9 can be coupled with each other via at least one dome 20. The braking to stop device is coupled on the input side with the electric motor actuator 7 such that a torque or a rotational motion created by the electric motor actuator 7, if the latter is suitably powered, can be transmitted in both possible drive directions of the electric motor actuator 7 to the drive body 8.

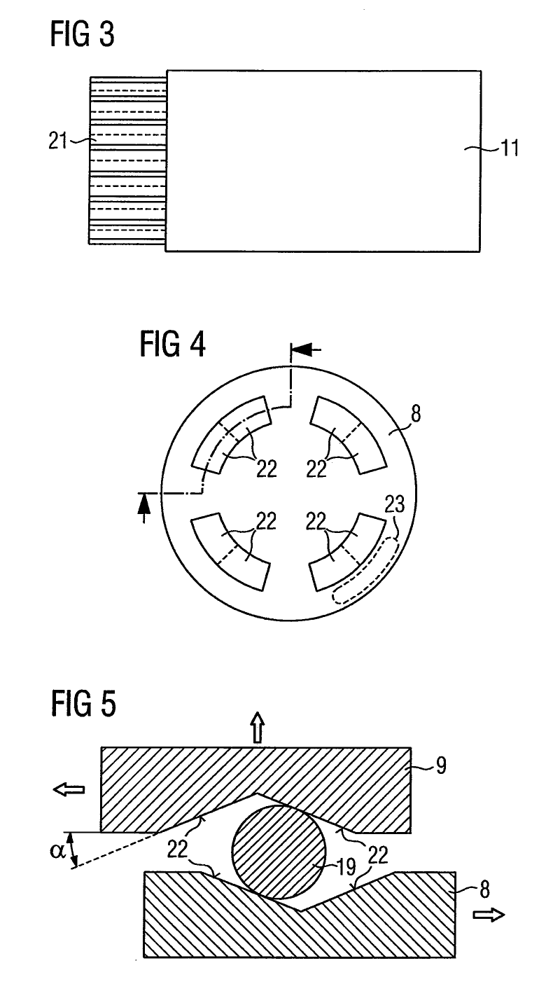

The braking body 9 is supported on the first shaft 11 so that it can be axially displaced. To this end the first shaft 11 has longitudinal teeth 21 at an axial end of its outside surface, for example a spline (FIG. 3). The braking body 9 has corresponding longitudinal teeth, so that the braking body 9 is arranged so that it can be axially displaced on the first shaft 11, however the braking body 9 is coupled rotationally with the first shaft 11 such that a torque can be transmitted from the braking body 9 to the first shaft 11 or from the first shaft 11 to the braking body 9.

The drive body 8 has four recesses embodied in a rotational direction, into which two ramp-shaped contours 22 arranged in opposite directions are embodied. Corresponding recesses and ramp-shaped contours 22 can be embodied in the drive body 8 and/or in the braking body 9. Either the drive body 8 or the braking body 9 can also be embodied differently as regards the recesses and/or the ramp-shaped contours 22, so that the positioning body 19 is prevented from rolling away if the drive body 8 twists against the braking body 9. Fewer, e.g. only one, two or three positioning bodies 19, or more than four positioning bodies 19 can be provided. Correspondingly fewer or more than four recesses can be provided, each with two ramp-shaped contours 22. The two ramp-shaped contours 22 arranged opposite one another make it possible to create the axial lifting for both possible drive directions of the electric motor actuator 7. If creating the axial lifting for one of the two possible drive directions of the electric motor actuator 7 is sufficient, then only one ramp-shaped contour 22 can also be provided in the relevant recess.

If necessary one or more recesses 23 can be provided in the drive body 8 and/or in the braking body 9, which for example are each embodied as a longitudinal slot in a rotational direction. A dome 20 can be introduced in each case into such a recess 23 for example, so that the torsion of the drive body 8 in relation to the braking body 9 is only possible in a predetermined angular range. The size of the predetermined angular range is for example around 20 to 60 degrees, but can also be larger or smaller than this.

A positioning body 19 is arranged between the drive body 8 and the braking body 9 in each of the four recesses. The positioning body 19 can be preferably embodied as a sphere or a cylinder, so that the positioning body 19 can roll up or down the ramp-shaped contours 22 with little friction. The positioning body 19 interoperates via the ramp-shaped contours 22 with the drive body 8 and the braking body 9 in such a way that a torsion of the drive body 8 in relation to the braking body 9 leads to an axial lifting of the axially displaceable braking body 9 (FIG. 5). The axial lifting of the braking body 9 allows this to be moved out of its braking position. In this way a highly-efficient transmission of the torque of the electric motor actuator 7 via the drive body 8, the positioning body 19 to the braking body 9 is possible. The transmission of the torque can, if necessary as an alternative to the positioning bodies 19, also be achieved via the at least one dome 20, in that when a predetermined torsion angle of the drive body 8 in relation to the braking body 9 is reached, the braking body 9 is included via the at least one dome 20 in its rotational motion.

The axial lifting of the braking body 9 on the first shaft 11 can be limited by a corresponding embodiment of the longitudinal teeth 21, e.g. an axial length the longitudinal teeth 21, or preferably by a collar. The collar is for example embodied by a diameter of the first shaft 11 in an area of the longitudinal teeth 21 being smaller being smaller than in an area adjoining the longitudinal teeth 21. The axial lifting of the braking body 9 can also be limited by the axial bearing 17 which may be provided on the housing 10. The axial bearing 17 is embodied to make a low-friction rotation of the braking body 9 possible, if the braking body 9 is lying for example for maximum axial lifting of the braking body 9 against the axial bearing 17. The axial lifting of the braking body 9 is likewise limited by the design of the recesses and of the ramp-shaped contours 22 and through any limitation of the torsion angle of the drive body 8 in relation to the braking body 9 provided by the at least one dome 20. Preferably the axial lifting of the braking body 9 on the first shaft 11 may be so great that the braking body 9 no longer touches the braking surface 16 of the housing 10 if the first shaft 11 is driven by the electric motor actuator 7. This means that losses through friction between the braking body 9 and braking surface 16 of the housing 10 are low and that efficiency is high. The axial lifting amounts to two millimeters for example, but can also be greater than or less than this.

The braking body 9 is for example embodied as a friction ring. The braking body 9 can however also be embodied in the form of a disk for example. The housing 10 then preferably also may feature disks as an alternative to the braking surface 16 which engage in the disks of the braking body 9. In the braking position of the braking body 9 the disks of the braking body 9 and of the housing 10 are pressed against each other. These can be separated from each other again by the axial lifting of the braking body 9.

The ramp-shaped contours 22 can be preferably embodied as flat surfaces, which are embodied inclined at an angle α in relation to a surface of the drive body 8 or of the braking body 9 respectively in a rotational direction. The ramp-shaped contours 22 can however also be embodied in the shape of curves for example. The angle α may be preferably embodied so that a power requirement of the electric motor actuator 7 for turning the drive body 8 in relation to the braking body 9 and thereby for creating the axial lifting of the braking body 9 is small.

A smaller angle α to create a predetermined axial lifting requires a greater torsion angle of the drive body 8 in relation to the braking body 9 by comparison with a large angle α, with which correspondingly only a smaller torsion angle of the drive body 8 in relation to the braking body 9 is necessary. A smaller angle α correspondingly requires only a low power of the electric motor actuator 7 by comparison with the large angle α.

The power requirement of the electric motor actuator 7 further depends on the force with which the spring element 18 presses the braking body 9 in the direction of the drive body 8. An opposing force created by the electric motor actuator 7 and exerted via the drive body 8 and the positioning body 19 on the braking body 9 must be greater than the force of the spring element 18, in order to be able to move the braking body 9 out of the braking position.

Furthermore the power requirement of the electric motor actuator 7 is dependent on the torque which is exerted by the first brake cable 4 and by the second brake cable 6 on the first cable sheave 13, the second cable sheave, the first output shaft 12, the second output shaft 14 and the braking body 9. The power of the electric motor actuator 7 can be preferably great enough to allow this torque to be countered and to make a desired adjustment of first cable sheave 13 and the second cable sheave 15 possible.

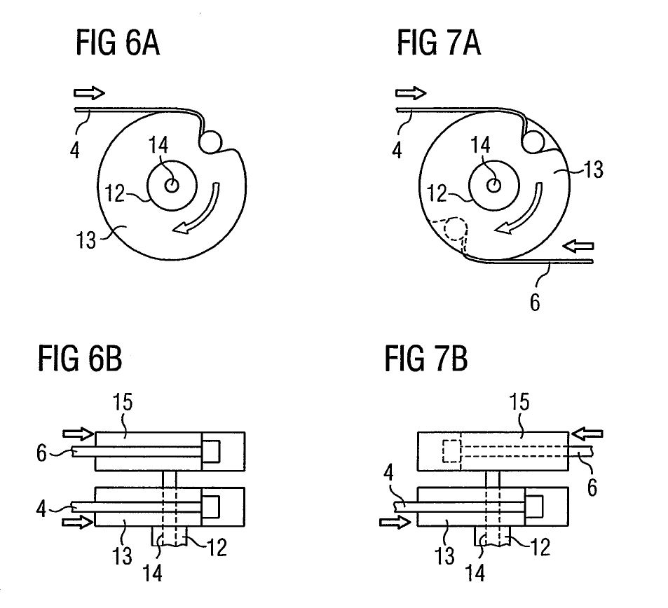

FIG. 6a and FIG. 6b show a first arrangement of the first cable sheave 13 and of the second cable sheave. In this first arrangement the first brake cable 4 and the second brake cable 6 can be pulled in parallel to one another and in the same direction. This first arrangement is especially suited to arranging the actuating device 5 for example in the central channel of the vehicle 1 (FIG. 1a).

FIG. 7a and FIG. 7b correspondingly show a second arrangement, in which the first cable sheave 13 and the second cable sheave 15 are arranged so that the first brake cable 4 and the second brake cable 6 can be pulled in opposite directions. To this end the second cable sheave 15 is for example arranged turned through around 180 degrees to the first cable sheave 13. This second arrangement is especially suitable for arranging the actuating device 5 in the area of the vehicle axle (FIG. 1b). By comparison with the first arrangement, the actuating device 5 in the second arrangement is arranged correspondingly turned through 90 degrees in the motor vehicle 1.

Other positioning elements can also be provided as alternates to the first cable sheave 13 and the second cable sheave 15, said elements each being able to be coupled with a transmission element, e.g. the first brake cable 4, the second brake cable 6 or also with a suitable rod.

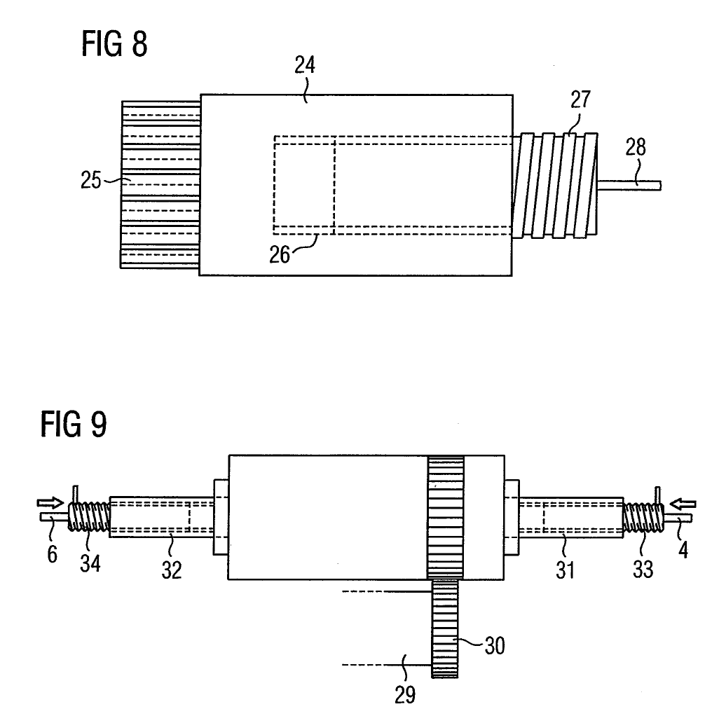

FIG. 8 shows a second shaft 24 with longitudinal teeth 25, which at its axial end facing away from the longitudinal teeth 25 features a hole with an internal thread 26. The second shaft 24 corresponds to the first shaft, but additionally includes a spindle drive which is formed by the internal thread 26. A first threaded spindle 27 is screwed into the internal thread 26, which is arranged to enable it to be displaced in an axial direction and is fixed in its rotational position, on the housing 10 for example. In this way a rotational motion of the second shaft 24 can be converted into a linear motion of the first threaded spindle 27. This linear motion can be transferred to a transmission element 28, said element being a brake cable or a rod for example. The second shaft 24 forms an output shaft of the actuating device 5.

The second shaft 24 can also be provided with an external thread. Accordingly the first threaded spindle 27 can also be embodied as a spindle nut and screwed onto the external thread of the second shaft 24.

FIG. 9 shows a further option for arranging output shafts of the actuating device 5. A third shaft 29, which corresponds to the first shaft 11, additionally includes a toothed wheel 30. A third output shaft 31 and a fourth output shaft 32 are embodied as spindles and are arranged along a common axis of rotation. A second threaded spindle 33 is screwed into the third output shaft 31 and a third threaded spindle 34 is screwed into the fourth output shaft 32. The second threaded spindle 33 and the third threaded spindle 34 are each arranged to enable them to be axially displaced and are fixed in their rotational position, for example on the housing 10. The third output shaft 31 and the fourth output shaft 32 are coupled with the third shaft 29 via the toothed wheel 30. Alternately the third output shaft 31 and the fourth output shaft 32 can also for example be coupled with the third shaft 29 via a drive belt. A rotational motion of the third output shaft 31 or of the fourth output shaft 32 respectively leads to a linear motion of the second threaded spindle 33 or of the third threaded spindle 34 respectively. A transmission element, e.g. the first brake cable 4 or the second brake cable 6 or a rod is coupled with the second threaded spindle 33 and to the third threaded spindle 34 respectively.

Preferably the third output shaft 31 and the fourth output shaft 32 can be coupled via a compensation gear with the third shaft 29. This for example enables different lengths, e.g. of the first brake cable 4 or of the second brake cable or different forces which operate in an axial direction on the second threaded spindle 33 or the third threaded spindle 34 to be compensated for. The arrangement depicted in FIG. 9 of the third output shaft 31 and the fourth output shaft 32 is especially advantageous if the actuating device 5 is arranged in an area on the axle of the vehicle and the first brake cable 4 and the second brake cable 6 run at right angles to the longitudinal direction of the vehicle (FIG. 1b).

The actuating device 5 can not only be used in motor vehicles but can be employed wherever a linear pulling force or pushing force is needed, which is also to be maintained if the electric motor actuator 7 is inactive, i.e. when no power is being supplied to it for example.

What is claimed is:

1. An actuating device, comprising
an electric motor actuator,
at least one output shaft,
at least one positioning element, which is coupled with the at least one output shaft and which is embodied for coupling with a transmission element and that interoperates with the transmission element to convert a rotational motion of the at least one output shaft into a linear motion of the transmission element,
a braking to stop device, which is coupled on the input side with the electric motor actuator and which is coupled with the at least one output shaft or forms a constructional unit with the at least one output shaft and which features a braking body which is coupled with the at least one output shaft and which is arranged to enable it to be axially displaced and which is embodied to convert an input-side rotational motion within a predetermined angular range into an axial lifting of the braking body out of a braking position of the braking body or into the braking position of the braking body and for transmitting the input-side rotational motion to the braking body.

2. The actuating device according to claim 1, wherein the braking to stop device is embodied for the respective transmission of the input-side rotational motion to the braking body for two opposing drive directions of the electric motor actuator.

3. The actuating device according to claim 1, wherein the braking to stop device includes a spring element which is embodied so that the spring element transmits an operating force to the braking body that causes the braking body to assume the braking position when the electric motor actuator is inactive.

4. The actuating device according to claim 1, wherein the braking body is embodied as a friction ring.

5. The actuating device according to claim 1, wherein the braking body is embodied in the form of a disk and is part of a disk brake.

6. The actuating device according to claim 1, wherein the braking to stop device comprises a drive body which is coupled with the electric motor actuator, and the drive body is coupled with the braking body via at least one positioning body.

7. The actuating device according to claim 6, wherein, on side of the drive body facing towards the braking body and/or on side of braking body facing towards the drive body at least one ramp-shaped contour is embodied for converting a rotational motion of the drive body into the axial lifting of the braking body interoperating with the at least one positioning body.

8. The actuating device according to claim 6, wherein the at least one positioning body is embodied in the form of a sphere or a cylinder.

9. The actuating device according to claim 1, wherein the at least one output shaft features a spindle drive.

10. The actuating device according to claim 1, wherein the at least one positioning element is embodied as a cable sheave.

11. An actuating device, comprising
an electric motor actuator,
an output shaft,
a positioning element coupled with the output shaft and which is embodied for coupling with a transmission element and which interoperates with the transmission element to convert a rotational motion of the at least one output shaft into a linear motion of the transmission element,
a parking brake, which is coupled on the input side with the electric motor actuator and with the at least one output shaft and which comprises a braking body which is coupled with the at least one output shaft and which is arranged to enable it to be axially displaced and which is embodied to convert an input-side rotational motion within a predetermined angular range into an axial lifting of the braking body out of a braking position of the braking body or into the braking position of the braking body and for transmitting the input-side rotational motion to the braking body.

12. The actuating device according to claim 11, wherein the parking brake is embodied for the respective transmission of the input-side rotational motion to the braking body for two opposing drive directions of the electric motor actuator.

13. The actuating device according to claim 11, wherein the parking brake includes a spring element which is embodied so that the spring element transmits an operating force to the braking body that causes the braking body to assume the braking position when the electric motor actuator is inactive.

14. The actuating device according to claim 11, wherein the braking body is embodied as a friction ring.

15. The actuating device according to claim 11, wherein the braking body is embodied in the form of a disk and is part of a disk brake.

16. The actuating device according to claim 11, wherein the parking brake comprises a drive body which is coupled with the electric motor actuator, and the drive body is coupled with the braking body via at least one positioning body.

17. The actuating device according to claim 16, wherein, on side of the drive body facing towards the braking body and/or on side of braking body facing towards the drive body at least one ramp-shaped contour is embodied for converting a rotational motion of the drive body into the axial lifting of the braking body interoperating with the at least one positioning body.

18. The actuating device according to claim 16, wherein the at least one positioning body is embodied in the form of a sphere or a cylinder.

19. The actuating device according to claim 11, wherein the at least one output shaft features a spindle drive.

20. The actuating device according to claim 11, wherein the at least one positioning element is embodied as a cable sheave.
